(19) United States
(12) Patent Application Publication
(10) Pub. No.: US 2026/0098620 A1
(43) Pub. Date: Apr. 9, 2026

(54) OPTICAL DEVICE AND VEHICLE INCLUDING THE SAME

(71) Applicant: HYUNDAI MOBIS CO., LTD., Seoul (KR)

(72) Inventors: Si Il Kim, Yongin-si (KR); Sang Hyun Cho, Yongin-si (KR); Min Ji Jin, Yongin-si (KR)

(73) Assignee: HYUNDAI MOBIS CO., LTD., Seoul (KR)

(21) Appl. No.: 18/958,632

(22) Filed: Nov. 25, 2024

(30) Foreign Application Priority Data
Oct. 8, 2024 (KR) 10-2024-0136723

(51) Int. Cl. F21S 41/24; F21S 41/255; F21W 102/13

(52) U.S. Cl. CPC F21S 41/24; F21S 41/255; F21W 2102/13

(57) ABSTRACT

An optical device that deliberately allows a portion of light incident from a light source to leak and the light having leaked to be re-incident while forming a new optical path. The optical device includes a light source, a light guide disposed in front of the light source to guide light incident from the light source forward through total reflection, and a light emission lens forming a beam pattern using light incident from the light guide. The light guide includes a light incidence portion and an optical path portion forming an optical path for light incident on the light incidence portion. The optical path portion includes a first optical path portion having an opening therein to allow a portion of light incident to leak and a second optical path portion including a re-incidence surface on which light having leaked through the opening is incident.

This application claims the benefit of Korean Patent Application No. 10-2024-0136723, filed on Oct. 8, 2024, which is hereby incorporated by reference as if fully set forth herein.

### BACKGROUND

### Field

The present disclosure relates to an optical device, which deliberately allows a portion of light incident from a light source to leak and the light having leaked to be re-incident while forming a new optical path, and a vehicle including the same.

### Discussion of the Related Art

In general, a vehicle is equipped with various lamps that emit light forward depending on an ambient environment and time of day to secure a driver's vision and inform other vehicles of its traveling path.

These lamps are categorized according to the purposes of use, such as a turn signal for securing the driver's vision and indicating the position of the vehicle, together with a headlamp for illuminating ahead of the vehicle, a fog lamp for securing the driver's vision and indicating the position of the vehicle in a foggy or rainy condition, together with the headlamp, a reverse light for lighting up when the vehicle is in reverse, and a brake light for lighting up when the driver applies the brakes.

Halogen bulbs are mainly used for conventional vehicle lamps. When a halogen lamp is used as a light source, there is a reflector that reflects light irradiated by the halogen lamp, and the reflected light is irradiated forward. However, while halogen lamps have the advantage of being inexpensive, they have the disadvantages of high heat generation during use, low brightness relative to the amount of electricity used, and short lifespans.

To solve these problems, vehicle lamps using light emitting diodes (LEDs) have emerged. LED lamps have the advantages of high brightness, long lifespans, and low power consumption.

Among the vehicle lamps, headlamps form low beam or high beam patterns to ensure the driver's forward vision when driving in dark surroundings such as at night, and play a very important role in driving.

A vehicle is equipped with a function of simultaneously or separately irradiating low beams to a short distance and high beams to a long distance in front of the vehicle.

From the driver's perspective, irradiating low beams and high beams simultaneously is the safest way to drive because it ensures the driver's vision for both the short and long distances in front of the vehicle.

However, high beams carry the risk of causing glare to the driver of an oncoming vehicle or an oncoming pedestrian, making it impossible to secure vision during a time required for light and dark adaptation.

In this regard, the driver continuously checks for oncoming vehicles or pedestrians and repeatedly turns high beams on and off, which also harms the safety of driving and causes considerable inconvenience to the driver.

To supplement this, driver assistance systems which automatically turn on and off high beams depending on the presence of an opposing vehicle or a preceding vehicle, or control the irradiation angle or brightness of low beams and high beams depending on road conditions (city, highway, intersection, and so on) have been developed and commercialized.

Recently, adaptive drive beam (ADB) technology has been developed to detect an opposing vehicle, a preceding vehicle, a pedestrian, and so on from a video image in front of the vehicle, and change a lamp irradiation angle or turn off the light source so that high beams are not irradiated to the location of a detected vehicle or pedestrian.

In addition, a total internal reflection (TIR) lens is used as an optical module capable of condensing light output from a light source with high efficiency through total internal reflection. However, the TIR lens has a short focal length due to the structural characteristics thereof, which may entail a problem of noncompliance with traffic regulations due to diffusion of emitted light.

If the focal length is formed to be long in the conventional TIR lens structure in order to solve the above problem, luminance efficiency deteriorates, and thus the advantage of high light condensing efficiency of the TIR lens is not obtained. In addition, if the amount of current applied to a light source is reduced, the luminous intensity of the light source is reduced, and thus the performance of the TIR lens structure deteriorates.

Therefore, there is need for a TIR lens structure capable of solving the above problems and increasing luminance efficiency while utilizing a TIR lens.

### SUMMARY

It is an object of the present disclosure to provide an optical device and a vehicle including the same, more particularly, an optical device, which deliberately allows a portion of light incident from a light source to leak and the light having leaked to be re-incident while forming a new optical path, and a vehicle including the same.

In addition, it is another object of the present disclosure to provide an optical device, which is capable of increasing luminance efficiency through the shape of an opening through which light leaks and the shape of a re-incidence surface on which the light having leaked is re-incident, and a vehicle including the same.

The objects to be accomplished by the disclosure are not limited to the above-mentioned objects, and other objects not mentioned herein will be clearly understood by those skilled in the art from the following description.

An optical device according to an embodiment of the present disclosure includes a light source, a light guide disposed in front of the light source and configured to guide light incident from the light source in a forward direction through total reflection, and a light emission lens configured to form a beam pattern using light incident from the light guide, wherein the light guide includes a light incidence portion and an optical path portion configured to form an optical path for light incident on the light incidence portion, and the optical path portion includes a first optical path portion having an opening therein to allow a portion of the light incident on the light incidence portion to leak and a second optical path portion including a re-incidence surface on which light having leaked through the opening is incident.

The first optical path portion may include an opening protrusion protruding from one surface of the first optical path portion, the opening protrusion may include an open front surface, and the opening may include the open front surface of the opening protrusion.

The opening protrusion may be inclined relative to the forward direction.

The open front surface of the opening protrusion may have a concavely curved shape, and the opening may have a shape corresponding to the concavely curved shape of the open front surface of the opening protrusion.

A width of the opening protrusion in a leftward-rightward direction may increase in a forward direction.

The opening may be in a lower portion of the first optical path portion.

The re-incidence surface may be inclined relative to the forward direction so that the light having leaked through the opening is incident on the re-incidence surface while being refracted.

The re-incidence surface may have a convexly curved shape.

The width of the opening in the leftward-rightward direction may be smaller than the width of the re-incidence surface in the leftward-rightward direction.

The light incidence portion may include a first incidence surface having a dome shape and a second incidence surface bent and protruding backward from the edge of the first incidence surface.

The light emission lens may include an emission surface having a curved shape that is convex as viewed in a direction opposing the forward direction.

The light emission lens may be integrally formed with the light guide or the light emission lens may be disposed so as to be spaced apart from the light guide.

The light incidence portion and the optical path portion may be integrally formed with each other or the light incidence portion and the optical path portion may be spaced apart from each other.

The beam pattern may include a high-beam pattern and a low-beam pattern.

A vehicle according to an embodiment of the present disclosure includes a vehicle body, a lamp structure located on a front surface or a rear surface of the vehicle body, and an optical device embedded in the lamp structure, wherein the optical device includes a light source, a light guide disposed in front of the light source and configured to guide light incident from the light source in a forward direction through total reflection, and a light emission lens configured to form a beam pattern using light incident from the light guide, the light guide includes a light incidence portion and an optical path portion configured to form an optical path for light incident on the light incidence portion, and the optical path portion includes a first optical path portion having an opening therein to allow a portion of the light incident on the light incidence portion to leak and a second optical path portion including a re-incidence surface on which light having leaked through the opening is incident.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a schematic view of an optical device according to an embodiment of the present disclosure;

FIGS. 2 and 3 are perspective views of the optical device according to the embodiment of the present disclosure;

FIG. 4 is an enlarged view of area A in FIG. 2;

FIG. 5 is a schematic view showing an opening formed in a first optical path portion so as to face forward in the optical device according to the embodiment of the present disclosure; and

FIG. 6 is a bottom view of the optical device according to the embodiment of the present disclosure.

### DETAILED DESCRIPTION

Description will now be given in detail according to exemplary embodiments disclosed herein, with reference to the accompanying drawings. The same or equivalent components may be provided with the same reference numbers, and description thereof will not be repeated. As used herein, the suffixes “module” and “part” are added or used interchangeably to facilitate preparation of this specification and are not intended to suggest distinct meanings or functions. In describing embodiments disclosed in this specification, relevant well-known technologies may not be described in detail in order not to obscure the subject matter of the embodiments disclosed in this specification. In addition, it should be noted that the accompanying drawings are only for easy understanding of the embodiments disclosed in the present specification, and should not be construed as limiting the technical spirit disclosed in the present specification. As such, the present disclosure should be construed to extend to any alterations, equivalents and substitutes in addition to those which are particularly set out in the accompanying drawings.

Although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, it will be understood that when an element is referred to as being “directly connected with” another element, there are no intervening elements present.

A singular representation may include a plural representation unless it represents a definitely different meaning from the context.

The terms such as “include” or “have” used herein are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

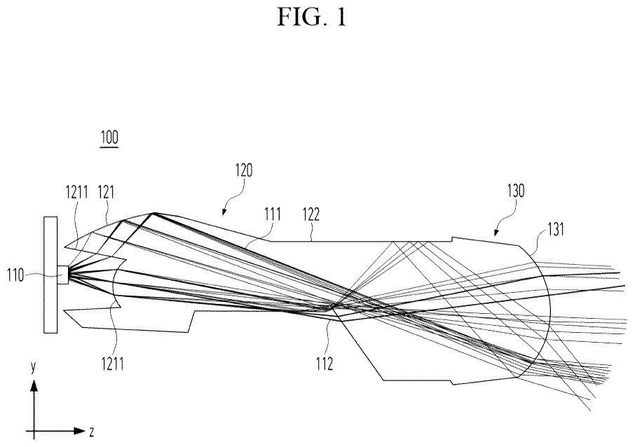

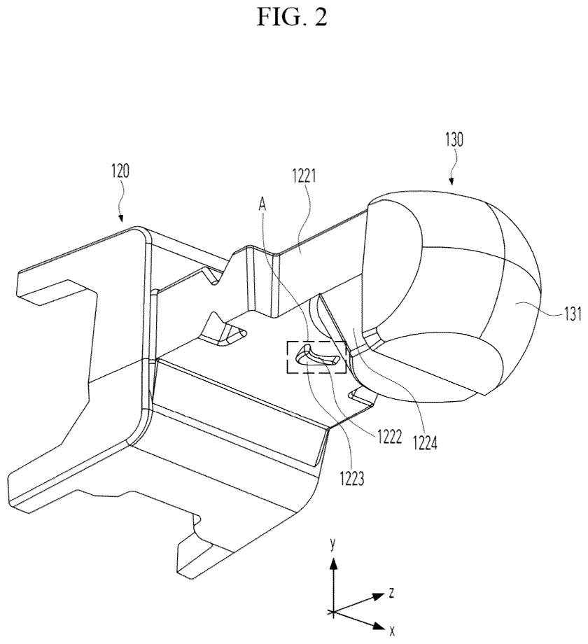

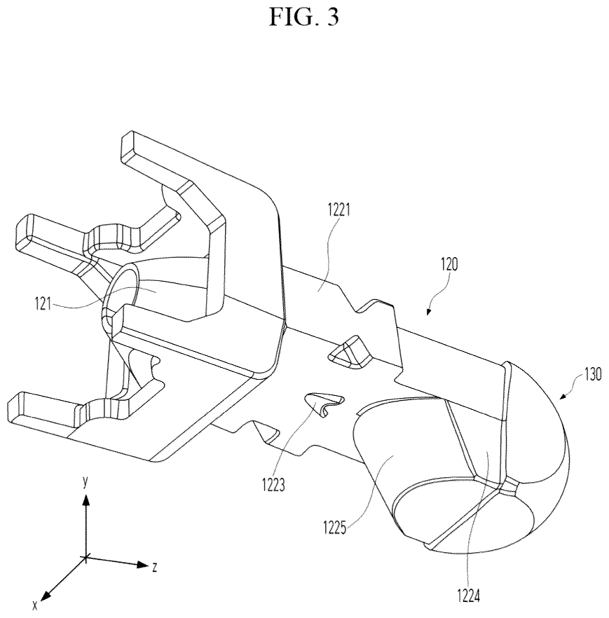

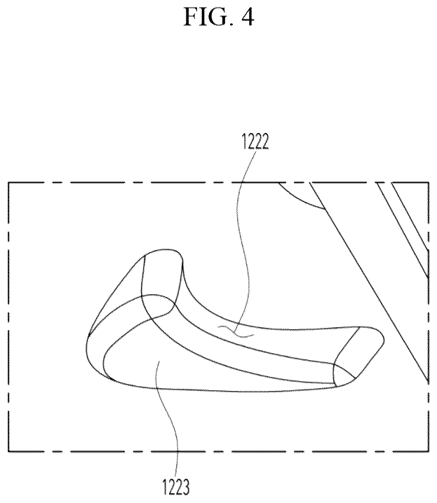

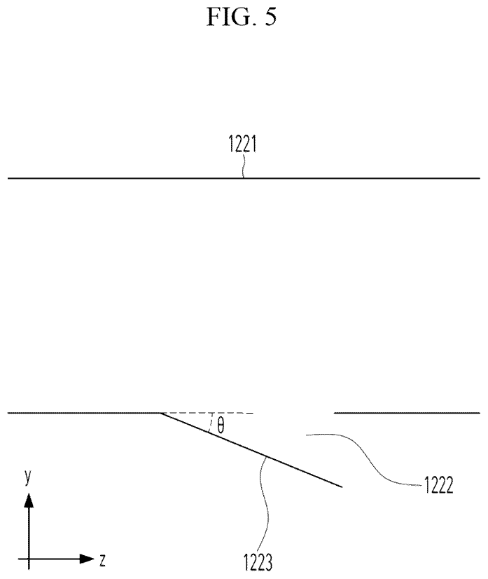

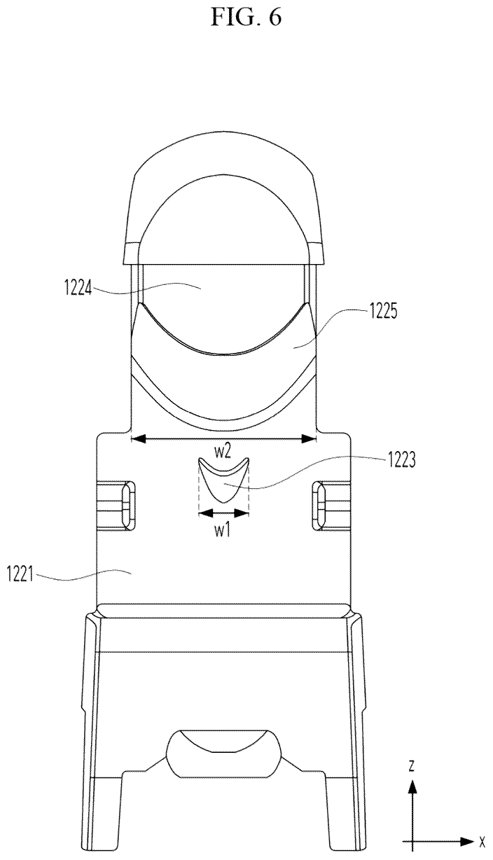

FIG. 1 is a schematic view of an optical device 100 according to an embodiment of the present disclosure. FIGS. 2 and 3 are perspective views of the optical device 100 according to the embodiment of the present disclosure. FIG. 4 is an enlarged view of area A in FIG. 2. FIG. 5 is a schematic view showing an opening 1222 formed in a first optical path portion 1221 so as to face forward (in a z-axis direction) in the optical device 100 according to the embodiment of the present disclosure. FIG. 6 is a bottom view of the optical device 100 according to the embodiment of the present disclosure.

The optical device 100 according to the embodiment of the present disclosure may be provided in a vehicle in a manner of being, for example, embedded in a lamp structure located on a front surface or a rear surface of the vehicle body. In addition, the optical device 100 of the present disclosure may include the above-described adaptive drive beam (ADB). In addition, the optical device 100 of the present disclosure may include the above-described total internal reflection (TIR) lens.

Hereinafter, in describing the optical device 100 according to the embodiment of the present disclosure, a leftward-rightward direction will be defined as an x-axis direction, an upward-downward direction will be defined as a y-axis direction, and a forward-backward direction will be defined as a z-axis direction.

Referring to FIGS. 1 to 3, the optical device 100 according to the embodiment of the present disclosure may include a light source 110, a light guide 120, and a light emission lens 130. The light source 110 may serve to output light. The light source 110 may be provided in plural, and the plurality of light sources 110 may be disposed in an array form.

The light guide 120 is disposed in front of the light source 110 (in the z-axis direction) and may serve to guide light 111 incident from the light source 110 forward (in the Z-axis direction) through total reflection. The light emission lens 130 may serve to form a beam pattern using the light 111 incident from the light guide 120. To this end, the light emission lens 130 may include an emission surface 131 having a curved shape formed to be convex forward (in the z-axis direction).

Here, the beam pattern formed by the light emission lens 130 may include, for example, a low-beam pattern for illuminating a short-distance region ahead of the vehicle and a high-beam pattern for illuminating a long-distance region ahead of the vehicle. The optical device 100 according to the embodiment of the present disclosure may simultaneously or separately implement the low-beam pattern and the high-beam pattern.

In the optical device 100 according to the embodiment of the present disclosure, the light guide 120 may include a light incidence portion 121 and an optical path portion 122 configured to form an optical path for the light 111 incident on the light incidence portion 121. Here, the light incidence portion 121 may include a first incidence surface 1211, which has a dome shape and is disposed in front of the light source 110 (in the z-axis direction), and a second incidence surface 1212, which is bent and protrudes backward (in the z-axis direction) from the edge of the first incidence surface 1211. The light output from the light source 110 may be efficiently incident on the light incidence portion 121 through the first incidence surface 1211 and the second incidence surface 1212.

The optical path portion 122 may include a first optical path portion 1221 and a second optical path portion 1224. In detail, referring also to FIG. 4, in the optical device 100 according to the embodiment of the present disclosure, the first optical path portion 1221 may have an opening 1222 formed therein to allow a portion of the light 111 incident on the light incidence portion 121 to leak. In addition, the second optical path portion 1224 may include a re-incidence surface 1225 on which light 112 having leaked through the opening 1222 is incident.

As described above, the TIR lens has high light condensing efficiency, but has a short focal length due to the structural characteristics thereof, which may entail a problem of noncompliance with traffic regulations due to diffusion of emitted light. Here, the traffic regulations include a light distribution regulation that regulates an angle of beam radiated to a region ahead of or behind the vehicle and a range between the maximum quantity of light and the minimum quantity of light.

If the focal length is formed to be long in the conventional TIR lens structure in order to solve the above problem, luminance efficiency deteriorates, and thus the advantage of high light condensing efficiency of the TIR lens is not obtained. In addition, if the amount of current applied to the light source 110 is reduced, the luminous intensity of the light source 110 is reduced, and thus the performance of the TIR lens structure deteriorates.

The optical device 100 according to the embodiment of the present disclosure deliberately allows a portion of the light 111 incident from the light source 110 to leak and the light 112 having leaked to be re-incident while forming a new optical path, thereby solving the above problems.

In more detail, in the optical device 100 according to the embodiment of the present disclosure, the opening 1222 may be formed in the first optical path portion 1221 to allow a portion of the light 111 incident on the light incidence portion 121 to leak therethrough. In addition, the re-incidence surface 1225, on which the light 112 having leaked through the opening 1222 is incident, may be formed at the second optical path portion 1224.

Referring also to FIGS. 4 to 6, in the optical device 100 according to the embodiment of the present disclosure, the first optical path portion 1221 may include an opening protrusion 1223 protruding from one surface thereof. The front surface of the opening protrusion 1223 may be open to form the opening 1222. That is, the opening 1222 may be formed by the opening protrusion 1223. Particularly, the opening 1222 may be formed to face forward (in the z-axis direction) by the opening protrusion 1223.

In addition, in the optical device 100 according to the embodiment of the present disclosure, the opening protrusion 1223 may be formed to be inclined forward (in the z-axis direction). In addition, the front surface of the opening protrusion 1223 may include a concavely curved shape. The opening 1222 may be formed in a shape corresponding to the shape of the front surface of the opening protrusion 1223. In addition, the opening protrusion 1223 may be formed such that the width w1 thereof in the leftward-rightward direction (the x-axis direction) gradually increases in the forward direction (the z-axis direction).

In the optical device 100 according to the embodiment of the present disclosure, the opening 1222 may be formed in a lower portion of the first optical path portion 1221. As shown in FIGS. 1 to 3, the second optical path portion 1224 having the re-incidence surface 1225 may be formed at a position corresponding to the opening 1222 so that the light 112 having leaked through the opening 1222 is incident on the re-incidence surface 1225.

In the optical device 100 according to the embodiment of the present disclosure, the re-incidence surface 1225 may be formed to be inclined forward (in the z-axis direction) so that the light 112 having leaked through the opening 1222 is incident thereon while being refracted. In addition, the re-incidence surface 1225 may include a convexly curved shape.

In more detail, the optical device 100 according to the embodiment of the present disclosure may allow a portion of the light 111 incident on the light incidence portion 121 to leak through the opening 1222 formed by the opening protrusion 1223. To this end, the opening protrusion 1223 may be formed to be inclined forward (in the z-axis direction).

In addition, in the optical device 100 according to the embodiment of the present disclosure, the front surface of the opening protrusion 1223 may include a concavely curved shape, and the opening 1222 may be formed in a shape corresponding to the shape of the front surface of the opening protrusion 1223. In this case, the re-incidence surface 1225 may include a convexly curved shape corresponding to the shape of the front surface of the opening protrusion 1223. Here, the aforementioned new optical path may be formed by adjusting the curvature of the curved shape of the front surface of the opening protrusion 1223 and the curvature of the curved shape of the re-incidence surface 1225.

In addition, the optical device 100 according to the embodiment of the present disclosure may adjust the angle θ at which the opening protrusion 1223 is inclined, as shown in FIG. 5. In addition, as shown in FIG. 6, the width w1 of the opening protrusion 1223 in the leftward-rightward direction (the x-axis direction) may be adjusted. In this way, the size of the opening 1222 may be adjusted. In addition, the quantity of light 112 leakage may be adjusted by adjusting the size of the opening 1222.

In addition, as shown in FIG. 6, in the optical device 100 according to the embodiment of the present disclosure, the width w1 of the opening 1222 in the leftward-rightward direction (the x-axis direction) may be formed to be smaller than the width w2 of the re-incidence surface 1225 in the leftward-rightward direction (the x-axis direction). The quantity of light 112 incident on the re-incidence surface 1225 after leaking through the opening 1222 may be adjusted by adjusting the width w1 of the opening 1222 in the leftward-rightward direction (the x-axis direction) or the width w2 of the re-incidence surface 1225 in the leftward-rightward direction (the x-axis direction).

As shown in FIG. 1, the optical device 100 according to the embodiment of the present disclosure deliberately allows a portion of the light 111 incident from the light source 110 to leak and the light 112 having leaked to be re-incident while forming a new optical path, thereby ensuring the advantage of high light condensing efficiency of the TIR lens, complying with traffic regulations, and improving the performance thereof.

In addition, in the optical device 100 according to the embodiment of the present disclosure, the light emission lens 130 may be integrally formed with the light guide 120 or may be disposed so as to be spaced apart from the light guide 120. Further, the light guide 120 may be formed such that the light incidence portion 121 and the optical path portion 122 are integrally formed with each other or spaced apart from each other. In this way, various optical paths may be formed, and accordingly, the beam pattern may be diversified.

As described above, the optical device and the vehicle including the same according to the present disclosure are configured to deliberately allow a portion of the light incident from the light source to leak and the light having leaked to be re-incident while forming a new optical path. In addition, luminance efficiency may be increased through the shape of the opening through which the light leaks and the shape of the re-incidence surface on which the light having leaked is re-incident.

As is apparent from the above description, according to an optical device and a vehicle including the same according to the present disclosure, it is possible to deliberately allow a portion of light incident from a light source to leak and the light having leaked to be re-incident while forming a new optical path.

In addition, it is possible to increase luminance efficiency through the shape of an opening through which the light leaks and the shape of a re-incidence surface on which the light having leaked is re-incident.

The effects achievable through the present disclosure are not limited to the above-mentioned effects, and other effects not mentioned herein will be clearly understood by those skilled in the art from the above description.

The above detailed description is to be construed in all aspects as illustrative and not restrictive. The scope of the present disclosure should be determined by reasonable interpretation of the appended claims and all changes coming within the equivalency range of the present disclosure are intended to be embraced in the scope of the present disclosure.

1. An optical device comprising:
a light source;
a light guide disposed in front of the light source, the light guide being configured to guide light incident from the light source in a forward direction through total reflection; and
a light emission lens configured to form a beam pattern using light incident from the light guide,
wherein the light guide comprises:
a light incidence portion; and
an optical path portion configured to form an optical path for light incident on the light incidence portion, and
wherein the optical path portion comprises:
a first optical path portion having an opening therein to allow a portion of the light incident on the light incidence portion to leak through the opening; and
a second optical path portion comprising a re-incidence surface on which light having leaked through the opening is incident.

2. The optical device according to claim 1, wherein the first optical path portion comprises an opening protrusion protruding from one surface of the first optical path portion,
wherein the opening protrusion comprises an open front surface, and
wherein the opening comprises the open front surface of the opening protrusion.

3. The optical device according to claim 2, wherein the opening protrusion is inclined relative to the forward direction.

4. The optical device according to claim 3, wherein the open front surface of the opening protrusion has a concavely curved shape, and
wherein the opening has a shape corresponding to the concavely curved shape of the open front surface of the opening protrusion.

5. The optical device according to claim 4, wherein a width of the opening protrusion in a leftward-rightward direction increases in the forward direction.

6. The optical device according to claim 1, wherein the opening is in a lower portion of the first optical path portion.

7. The optical device according to claim 1, wherein the re-incidence surface is inclined relative to the forward direction so that the light having leaked through the opening is incident on the re-incidence surface while being refracted.

8. The optical device according to claim 7, wherein the re-incidence surface has a convexly curved shape.

9. The optical device according to claim 1, wherein a width of the opening in a leftward-rightward direction is smaller than a width of the re-incidence surface in the leftward-rightward direction.

10. The optical device according to claim 1, wherein the light incidence portion comprises:
a first incidence surface having a dome shape; and
a second incidence surface bent and protruding backward from an edge of the first incidence surface.

11. The optical device according to claim 1, wherein the light emission lens comprises an emission surface having a curved shape that is convex as viewed in a direction opposing the forward direction.

12. The optical device according to claim 1, wherein the light emission lens is integrally formed with the light guide or the light emission lens is disposed so as to be spaced apart from the light guide.

13. The optical device according to claim 1, wherein the light incidence portion and the optical path portion are integrally formed with each other or the light incidence portion and the optical path portion are spaced apart from each other.

14. The optical device according to claim 1, wherein the beam pattern comprises a high-beam pattern and a low-beam pattern.

15. A vehicle comprising:
a vehicle body;
a lamp structure located on a front surface or a rear surface of the vehicle body; and
an optical device embedded in the lamp structure,
wherein the optical device comprises:
a light source;
a light guide disposed in front of the light source, the light guide being configured to guide light incident from the light source in a forward direction through total reflection; and
a light emission lens configured to form a beam pattern using light incident from the light guide,
wherein the light guide comprises:
a light incidence portion; and
an optical path portion configured to form an optical path for light incident on the light incidence portion, and
wherein the optical path portion comprises:
a first optical path portion having an opening therein to allow a portion of the light incident on the light incidence portion to leak through the opening; and
a second optical path portion comprising a re-incidence surface on which light having leaked through the opening is incident.
